(19) United States
(12) Patent Application Publication
(10) Pub. No.: US 2004/0101696 A1
(43) Pub. Date: May 27, 2004

(54) Double-sided copper clad laminate and method for manufacturing the same

(76) Inventors: Kazuhiro Yamazaki, Saitama (JP); Tetsuro Sato, Saitama (JP)

Correspondence Address: ROTHWELL, FIGG, ERNST & MANBECK, P.C., 1425 K STREET, N.W., SUITE 800, WASHINGTON, DC, 20005, US

(21) Appl. No.: 10/448,431

(22) Filed: May 30, 2003

(30) Foreign Application Priority Data
May 30, 2002 (JP) P2002-157067
Dec. 20, 2002 (JP) P2002-370740

(51) Int. Cl. B32B 15/08

(52) U.S. Cl. 428/457

(57) ABSTRACT

The present invention provides a double-sided copper clad laminate which enables the interlayer withstand voltage of a copper clad laminate used for the formation of a capacity layer to be more easily measured and a method for manufacturing this double-sided copper clad laminate. The invention is based on the use of a double-sided copper clad laminate 1a, etc. in which copper foil is clad to both sides of a dielectric layer, wherein the copper foil shape on both sides of the double-sided copper clad laminate is in an analogous relation, with the size of first copper foil 2 on one side being smaller than that of second copper foil 4 on the other side, the first copper foil 2 and the second copper foil 4 being disposed concentrically via the dielectric layer 3, and wherein a peripheral portion of an edge end of the side of the double-sided copper clad laminate to which the first copper foil 2 is clad has a dielectric region in which the dielectric layer is exposed.

### BACKGROUND OF THE INVENTION

1. Field of the Invention

The present invention relates to a double-sided copper clad laminate and a method for manufacturing this double-sided copper clad laminate. More particularly, it relates to a copper clad laminate which has a thin dielectric layer suitable for forming an inner capacity layer of a multilayer printed wiring board and which permits the measurement of interlayer withstand voltage in the state of the copper clad laminate and a method of continuously manufacturing this copper clad laminate.

2. Description of the Related Art

A double-sided copper clad laminate as a basic material for printed wiring boards has hitherto been widely used as a component material for double-sided printed wiring boards and multilayer printed wiring boards. This double-sided copper clad laminate has been manufactured by applying copper foil on both sides of a dielectric layer component material, such as a prepreg which is obtained by impregnating a glass cloth etc. with a semicuring resin, which is to constitute a dielectric layer, and a semicuring resin sheet, and hot pressing this dielectric layer component material.

A general practice hitherto adopted in this conventional manufacturing method involves providing a plurality of daylights between a set of heating press plates, laminating copper foil and a dielectric layer component material for composing a plurality of double-sided copper clad laminates between the daylights, and cladding the copper foil and the dielectric layer component material in multiple layers by hot pressing. Pressing conditions are set in such a manner that the semicuring resin begins to reflow to the dielectric layer component material and flows out of the end portions of the copper clad laminate over a given distance. This is because it is necessary to promote the removal of air present between a skeleton material, such as a glass cloth, and the resin used for impregnation, to improve the wettability of the copper foil clad surfaces by the resin, and to improve the bonding strength between the copper foil and the dielectric layer.

Under such a method, the section of a copper clad laminate observed immediately after hot pressing is as shown in the schematic representation of FIG. 7(A). After that, the end portions of this copper clad laminate are cut by use of a shearing cutter etc. and a copper clad laminate as a product is completed (patent literature 1: Japanese Patent Laid-Open No. 2001-177212).

However, when a copper clad laminate having a thin dielectric layer as used for the formation of a capacity layer is subjected to end portion processing as described above, it follows that the phenomenon as very schematically shown in FIGS. 7(A) and 7(B) occurs. A pressed copper clad laminate is in a condition shown in FIG. 7(A). When the end portions of this copper clad laminate are cut by the edges of a shearing cutter from up to down, the top side copper foil is elongated and stretched toward the bottom side copper foil as the edges of the shearing cutter move because copper itself is a soft material, with the result that the leading ends of the top side copper foil comes into contact with the bottom side copper foil. That is, the top side copper foil comes into a state as shown in FIG. 7(B).

In this state, the copper foil layers on both sides form a short circuit and it becomes impossible to measure the interlayer withstand voltage of a double-sided copper clad laminate used for the formation of a capacity layer in the stage of the double-sided copper clad laminate. Therefore, it becomes impossible for copper clad laminate makers to perform complete quality assurance because they cannot check interlayer resistance as a double-sided copper clad laminate for the formation of a capacity layer.

It is also possible to conceive that if such a state as shown in FIG. 7(A) is generated, the end portions of a copper clad laminate after the cutting thereof by use of a shearing cutter are polished by polishing means such as a grinder to produce good end surfaces. However, in the case of a double-sided copper clad laminate used for the formation of a capacity layer, a problem arises even when good end surfaces are produced.

That is, a thin dielectric layer is common to double-sided copper clad laminates used for the formation of a capacity layer. Particularly in recent years, even double-sided copper clad laminates having a dielectric layer which is as thin as 20 μm or so have been manufactured. When a double-sided copper clad laminate has such a thin dielectric layer and copper foil layers are present up to the end portions of the copper clad laminate, the discharge phenomenon occurs at the edge portions of the copper foil on both sides between the end portions of the copper clad laminate, which are indicated by arrows in FIG. 8, and it becomes almost impossible to accurately measure withstand voltage. In particular, the interlayer withstand voltage test of a copper clad laminate used for the formation of a capacity layer is conducted by applying a high voltage of not less than 500 V and hence the discharge phenomenon becomes likely to occur in the edge portions of the copper foil at the end portions of the copper clad laminate.

In view of the foregoing, those skilled in the art have made proposals about copper clad laminates permitting withstand voltage measurement by various contrivances. However, it has been required to provide a product which is quality assured by measuring the interlayer withstand voltage of a copper clad laminate for the formation of a capacity layer in a simpler way in the state of the copper clad laminate.

### SUMMARY OF THE INVENTION

Hence, the present inventors have devoted themselves to earnest research and, as a result, made it possible to measure the interlayer withstand voltage of a copper clad laminate for the formation of a capacity layer in the state of the copper clad laminate by adopting a structure of a double-sided copper clad laminate, which will be described below.

A first double-sided copper clad laminate proposed by the present inventors will be described below. According to a claim, there is provided a double-sided copper clad laminate for the formation of a capacity layer in which copper foil is clad to both sides of a dielectric layer. In this double-sided copper clad laminate, the copper foil shape on both sides of the double-sided copper clad laminate is in an analogous relation, with the size of first copper foil on one side being smaller than that of second copper foil on the other side, the first copper foil and the second copper foil being disposed concentrically via the dielectric layer. And in this double-sided copper clad laminate, a peripheral portion of an edge end of the side of the double-sided copper clad laminate to which the first copper foil is clad has a dielectric region in which the dielectric layer is exposed.

This double-sided copper clad laminate 1a is shown in FIGS. 1(A) and 1(B). FIG. 1(A) schematically shows the double-sided copper clad laminate 1a as viewed from the top surface and FIG. 1(B) schematically shows the double-sided copper clad laminate 1a as viewed from the section. As shown in FIG. 1(A), the configuration of this double-sided copper clad laminate is such that there is a region in which a dielectric layer 3 is exposed is present in the peripheral portion of clad first copper foil 2. This configuration enables a given distance to be produced in a gap between the first copper foil 2 and second copper foil 4. Besides, the surface of the second copper foil 4 opposed to the first copper foil 2 is completely covered with a material which constitutes the dielectric layer 3. As a result, even in the case of the double-sided copper clad laminate 1a in which the dielectric layer 3 is thinner than 20 μm, it becomes possible to prevent discharge in the edge portions of the first copper foil 2 and the second copper foil 4 and thereby to measure interlayer withstand voltage by applying a voltage of not less than 500 V.

Therefore, how to cover the surface of the second copper foil 4 where the dielectric layer 3 does not overlap with the first copper foil 2 is not especially limited. It is necessary only that at least the protruding surface of the second copper foil 4 be completely covered. It can also be said that even if the relevant surface of the second copper foil 4 is not completely covered, it is necessary only that the shortest distance between the end portions of the exposed second copper foil 4 and the first copper foil 2 be capable of being maintained at a distance which can prevent discharge.

Strictly speaking, it is desirable to determine the width of a region in which the dielectric layer 3 is exposed according to a voltage applied to an interlayer part between the first copper foil 2 and the second copper foil 4. The lower the applied voltage, the more it becomes possible to reduce the width of this region. Hence, the present inventors have devoted themselves to earnest research and, as a result, found that a distance of 1 μm per V is necessary. Therefore, to perform withstand voltage measurement by applying a voltage of 500 V, at least a width of 500 μm (0.5 mm) is necessary.

Hence, according to a claim, in the double-sided copper clad laminate for the formation of a capacity layer, the dielectric region has a width which is not less than V×1 μm from the edge end portion of the double-sided copper clad laminate, a load voltage during the measurement of withstand voltage being expressed by V voltage.

By using this double-sided copper clad laminate, it becomes possible to perform shape design of the double-sided copper clad laminate for performing a withstand voltage test suitable for a required voltage of the capacity layer. As a result, it becomes unnecessary to have an unnecessarily wide dielectric region. This enables work-size plates from a copper clad laminate for which press working has been completed to be taken at a maximum efficiency, permitting a total cost reduction by minimizing waste in the consumption of the material.

As a double-sided copper clad laminate which provides the same effect as with the above-described first double-sided copper clad laminate, there is described in another claim that in a double-sided copper clad laminate for the formation of a capacity layer in which copper foil is clad to both sides of a dielectric layer, the shape of first copper foil on one side and that of second copper foil on the other side are almost the same, the first copper foil and the second copper foil are disposed concentrically via the dielectric layer and the dielectric layer protrudes beyond the edge end portions of the first copper foil and the second copper foil.

This second double-sided copper clad laminate 1b is schematically shown in FIGS. 2(A) and 2(B). As is apparent from FIG. 2(A), when the double-sided copper clad laminate 1b is observed from above, it is seen that a dielectric layer 3 protrudes to the whole peripheral portion. And the protruding condition of the dielectric layer 3 present between first copper foil 2 and second copper foil 4 is more clearly apparent from the schematic sectional view of FIG. 2(B). Owing to this shape, the end portions of the first copper foil 2 and second copper foil 4 are completely shut off by the dielectric layer 3, with the result that it is possible to avoid the discharge phenomenon even when withstand voltage is measured by applying a high voltage to between the first copper foil 2 and the second copper foil 4.

The outstanding performance of this second double-sided copper clad laminate 1b is as follows. First, manufacturing can be easily performed because ordinary press working is performed, with a dielectric sheet, which constitutes a dielectric layer having a size larger than the copper foil disposed on both sides, sandwiched. Second, in the case of the first double-sided copper clad laminate 1a, it was necessary to consider the width of the dielectric region according to the voltage applied during the measurement of interlayer withstand voltage, whereas in the second double-sided copper clad laminate, almost all voltages used in the current measurement of the withstand voltage of the capacity layer are applicable by keeping the protruding distance of the dielectric layer at a level of at least not less than 2 mm, thus providing a great merit.

It is possible to use various types of resins, such as epoxy resins and polyimide resins, as a component resin of the dielectric layer and such resins do not need to be especially limited so long as they can be used in the manufacturing process of copper clad laminates. In a case where a dielectric filler is caused to be contained in the dielectric layer, the above-described component resin of the dielectric layer is used as a binder resin, a dielectric-filler-containing resin solution is produced by causing the dielectric filler to be contained in this binder resin, and the inductive layer is formed by uniformly applying this dielectric-filler-containing resin solution to the surface of the copper foil thereby to form dielectric-layer-formed copper foil.

Dielectric powders of conjugated oxides having the perovskite structure, such as BaTiO₃, SrTiO₃, PbZrₓTi₁₋ₓ (commonly called PZT), Pb₁₋ₓLa_{y}ZrₓTi₁₋ₓO₃ (commonly called PLZT), SrBi₂Ta₂O₉ (commonly called SBT), and other ferroelectric ceramic powders can be used in this dielectric filler.

However, it is preferred that the dielectric filler have powder characteristics as described below. First, it is necessary that the particle diameter of the dielectric filler which is a powder be in the range of 0.05 to 1.0 μm. The “particle diameter” called here refers to an average particle diameter which is obtained by directly observing the dielectric filler under a scanning electron microscope (SEM) and by performing an image analysis of an SEM image of the dielectric filler, because powder particles form a certain secondary coagulating state, with the result that it is impossible to adopt indirect measurement which involves, for example, estimating an average particle diameter from measured values obtained by the laser diffraction scattering type particle diameter diffusion measuring method and the BET method because of low accuracy. In the present specification, the particle diameter at this time is expressed as D_{IA}. Incidentally, in the image analysis of powders of dielectric filler observed under a scanning electron microscope (SEM) in the present specification, a round particle analysis was performed on the basis of a roundness threshold value of 10 and a degree of overlap of 20 by use of IP-1000PC made by Asahi Engineering Co., Ltd. and the average particle diameter D_{IA} was found.

Furthermore, it is required that the dielectric filler be a dielectric powder having a roughly spherical shape whose weight-cumulative particle diameter D₅₀ by the laser diffraction scattering type particle diameter diffusion measuring method is 0.1 to 2.0 μm and whose degree of aggregation expressed by D₅₀/D_{IA} by use of the weight-cumulative particle diameter D₅₀ and the average particle diameter D_{IA} obtained by an image analysis is not more than 4.5.

The “weight-cumulative particle diameter D₅₀ by the laser diffraction scattering type particle diameter diffusion measuring method” refers to a particle diameter at a weight accumulation of 50% obtained by the laser diffraction scattering type particle diameter diffusion measuring method. The smaller the value of this weight-cumulative particle diameter D₅₀, the higher the ratio of fine powder particles in the particle diameter distribution of dielectric filler powder. In the present invention, it is required that this value be 0.1 μm to 2.0 μm. That is, at a value of weight-cumulative particle diameter D₅₀ of less than 0.1 μm, no matter what manufacturing method is adopted in making a dielectric filler powder, the progress of aggregation is remarkable and the degree of aggregation will not satisfy the degree of aggregation, which will be described below. On the other hand, when the value of weight-cumulative particle diameter D₅₀ exceeds 2.0 μm, it becomes impossible to use the dielectric layer as a dielectric filler for the formation of a built-in capacitor layer of a printed wiring board, which provides the object of the present invention. That is, the dielectric layer of a double-sided copper clad laminate used for the formation of a built-in capacitor layer usually has a thickness of 10 μm to 25 μm and in order to uniformly disperse the dielectric filler in the dielectric layer, the upper limit of the dielectric layer thickness is 2.0 μm.

The measurement of the weight-cumulative particle diameter D₅₀ in the present invention was performed by mixing and dispersing a dielectric filler powder in methyl ethyl ketone and putting this solution into a circulator of a laser diffraction scattering type particle diameter distribution measuring device Micro Trac HRA Type 9320-X100 (made by Nikkiso Co., Ltd.).

The concept of the degree of aggregation used here was adopted for the reason described below. That is, it might be thought that the value of the weight-cumulative particle diameter D₅₀, which is obtained by the laser diffraction scattering type particle diameter distribution measuring method is not a result of an actual direct observation of the diameter of each powder particle. This is because powder particles which constitute almost all dielectric powders are not what is called an isolated dispersed power, in which individual particles are completely separated, and are in a state in which multiple powder particles aggregate and coalesce. And this is because it might be thought that in the laser diffraction scattering type particle diameter distribution measuring method, the weight-cumulative particle diameter is calculated by regarding powder particles which coalesce as one particle (an aggregated particle).

In contrast, because the average particle diameter D_{IA} obtained by an image processing of an observation image of a dielectric powder observed under a scanning electron microscope is obtained directly from the SEM observation image, primary particles are positively caught but on the other hand, the presence of the aggregation state of powder particles is not reflected in the least.

On the basis of the above conception, the present inventors have decided to regard the value calculated as D₅₀/D_{IA} by use of the weight-cumulative particle diameter D₅₀ by the laser diffraction scattering type particle diameter distribution method and the average particle diameter D_{IA} obtained by an image analysis as the degree of aggregation. That is, on the assumption that the value of D₅₀ and that of D_{IA} can be measured with the same accuracy in copper powders of the same lot, it might be thought, on the basis of the above theory, that the value of D₅₀ which reflects the fact that the aggregation state exists in measured values becomes larger than that of D_{IA} (similar effects are obtained also in actual measurement).

If at this time, the aggregation state of the powder particles of the dielectric filler powder goes out of existence completely, the value of D₅₀ approximates the value of D_{IA} limitlessly and it follows that the value of D₅₀/D_{IA}, which is the degree of aggregation, approximates 1. At the stage at which the degree of aggregation has become 1, it can be said that the pertinent particle powder is an isolated dispersed power completely free form the aggregation state of the particle powder. In actuality, however, there are also cases where the degree of aggregation shows a value of less than 1. Theoretically speaking, in the case of a true sphere, the degree of aggregation does not become a value of less than 1. In actuality, however, it seems that values of degree of aggregation of less than 1 are obtained because powder particles are not true spheres.

In the present invention, it is required that the degree of aggregation of this dielectric filler powder be not more than 4.5. If the degree of aggregation exceeds 4.5, the level of aggregation of the powder particles of the dielectric filler becomes too high and it becomes difficult to uniformly mix the dielectric filler with the binder resin.

Even when any of the manufacturing methods, such as the alkoxide method, the hydrothermal synthesis method and the oxalate method, is adopted as a method of manufacturing a dielectric filler powder, the state of a certain aggregation is inevitably formed and, therefore, there is a possibility that a dielectric filler powder which does not satisfy the above-described degree of aggregation may be generated. Particularly in the case of the hydrothermal synthesis method that is a wet method, the formation of the state of aggregation tends to occur. Therefore, by performing the particle dissociation treatment which involves separating the powder in this aggregation state into individual powder particles, it is possible to bring the aggregation state of the dielectric filler powder into the above-described range of the degree of aggregation.

If the purpose is only performing the particle dissociation work, it is possible to use various devices, such as a high-energy ball mill, a high-speed conductor collision type airstream grinder, an impact grinder, a gauge mill, a medium stirring type mill and a high water pressure grinder, as means capable of performing particle dissociation. However, in order to obtain the mixability and dispersibility of the dielectric filler powder and binder resin, it is necessary to consider a reduction in viscosity as a dielectric-filler-containing resin solution as will be described below. In reducing the viscosity of a dielectric-filler-containing resin solution, it is required that the specific surface area of the powder particles of the dielectric filler and the surface of the powder particles be smooth. Therefore, a particle dissociation technique to be adopted should not be such that even when particle dissociation is possible, the surfaces of the powder particles are damaged during particle dissociation, thereby increasing the specific surface area of the powder particles.

The present inventors devoted themselves to earnest research on the basis of such recognition and, as a result, found that two techniques are effective. What is common to these two techniques is that particle dissociation is made quite possible by minimizing the contact of the powder particles of the powder of the dielectric filler with the inside wall part and stirring blade of the device and the grinding medium, etc. and by causing the powder particles which have aggregated to collide with each other. That is, the contact of the powder particles of the powder of the dielectric filler with the inside wall part and stirring blade of the device and the grinding medium, etc. results in damaged surfaces of the powder particles, increased surface roughness and a lowered sphericity and hence this is to be prevented. And by causing powder particles to collide with each other sufficiently, the powder particles in the aggregation state are dissociated and, at the same time, the surfaces of the powder particles are made smooth by the collision of the powder particles with each other. Techniques which permit the foregoing can be adopted.

In one technique, a dielectric filler powder in the aggregation state is subjected to particle dissociation treatment by use of a jet mill. The “jet nill” called here refers to a device which uses a high-velocity airstream, puts the dielectric filler powder in this airstream, and performs the particle dissociation work by causing powder particles to collide with each other in the airstream.

In the other technique, slurry which is obtained by dispersing a dielectric filler powder in the aggregation state in a solvent which does not collapse the stoichiometry of this dielectric filler powder is subjected to particle dissociation treatment by use of a fluid mill which utilizes a centrifugal force. By using the “fluid mill which utilizes a centrifugal force” called here, the relevant slurry is caused to flow at a high velocity so as to describe a circumferential trajectory, powder particles which have aggregated are caused to collapse with each other in a solvent by use of the centrifugal force generated at this time thereby to perform the particle dissociation work. As a result of this, by cleaning, filtering and drying the slurry for which the particle dissociation work has been completed, a dielectric filler powder for which the particle dissociation work has been completed is obtained. By using the above-described methods it is possible to adjust the degree of aggregation and to smooth the powder surface of the dielectric filler powder.

A dielectric-filler-containing resin for the formation of a built-in capacitor layer of a printed wiring board is obtained by mixing the above-described binder resin and dielectric filler with each other. For the blending ratio of the binder resin and dielectric filler, it is desirable that the dielectric filler content be 75% by weight to 85% by weight, the balance being the binder resin.

When the dielectric filler content is less than 75% by weight, the dielectric constant of 20 which is at present requited in the market cannot be satisfied. When the dielectric filler content exceeds 85% by weight, the binder resin content becomes less than 15% by weight and the adhesion between the dielectric-filler-containing resin and the copper foil to be clad to this resin is impaired, with the result that it becomes difficult to manufacture a copper clad laminate which satisfies the properties required by the manufacturing of printed wiring boards.

When the manufacturing accuracy of this dielectric filler as a powder in the current stage is considered, it is desirable to use barium titanate among conjugated oxides having the perovskite structure. In this case, either calcined barium titanate or uncalcined barium titanium can be used as the dielectric filler. Although it is desirable to use calcined barium titanate when a high permittivity is to be obtained, a selection may be made according to the design quality of a printed wiring board product.

Furthermore, it is most preferred that the dielectric filler of barium titanate have a cubic system crystal structure. Although a cubic system and a tetragonal system exist as the crystal structures of barium titanate, the dielectric filler of barium titanium having the cubic system provides a more stable value of permittivity of a finally obtained dielectric layer than in a case where the dielectric filler of barium titanium having the tetragonal system alone is used. Therefore, it can be said that it is necessary to use at least a barium titanium powder having crystal structures of both the cubic system and the tetragonal system.

An excellent product is obtained when the dielectric layer of a double-sided copper clad laminate for the formation of a built-in capacitor layer of a printed wiring board by using the dielectric-filler-containing resin described above. In a built-in capacitor formed by using this double-sided copper clad laminate, it is possible to freely select the thickness of the dielectric layer, with the result that high capacitor quality having excellent capacitance is obtained.

Furthermore, as a result of earnest research it has become apparent that it is necessary only that the protruding distance of the dielectric layer from the edge end portion of the copper foil layer of the double-sided copper clad laminate be not less than V×1 μm as with the case of use of the first double-sided copper clad laminate. Although it might be thought that the longer this protruding distance, the higher the measurement reliability during withstand voltage measurement. However, if this length is unnecessarily large, this leads to waste in the consumption of raw materials. Hence, it might be thought that in actual use, a necessary minimum value is adopted from the standpoint of a raw material cost reduction.

It becomes unnecessary to change the shape design of a substrate according to the voltage used in inspection because the structure of the second double-sided copper clad laminate is adopted and, therefore, it is possible to achieve a high production efficiency. However, because of the presence of the protruding portion of the dielectric layer 3, this protruding portion becomes apt to be damaged during the handling of the copper clad laminate. It is necessary to use care particularly when the dielectric layer 3 is constituted from a hard, brittle dielectric material. Therefore, it is desirable to adopt a type of this double-sided copper clad laminate 2 in which the material for the dielectric layer 3 has flexibility to a certain degree even after curing as in the case where this material is mainly composed of a polyimide resin.

Furthermore, according to a claim for the third double-sided copper clad laminate, there is provided a double-sided copper clad laminate for the formation of a capacity layer which uses first dielectric-layer-formed copper foil, which is dielectric-layer-formed copper foil in which a dielectric layer having a prescribed thickness is formed beforehand on a bonding surface of the copper foil, and this dielectric layer and that of second dielectric-layer-formed copper foil are clad together. In this third double-sided copper clad laminate, in only a region of a peripheral edge end of the double-sided copper clad laminate having a width of not less than 5 mm, the dielectric layers of the first dielectric-layer-formed copper foil and the second dielectric-layer-formed copper foil are in an unbonded state.

This double-sided copper clad laminate 1c is schematically shown in FIGS. 3A and 3B. The feature of this double-sided copper clad laminate 1c resides in that, as is apparent from the sectional view of FIG. 3(B) and the enlarged view of an end portion of the double-sided copper clad laminate, in only a region of a peripheral edge end of the double-sided copper clad laminate 1c having a width of not less than 5 mm, the dielectric layers 3a, 3b of the first dielectric-layer-formed copper foil 5a and the second dielectric-layer-formed copper foil 5b are in an unbonded state. The unbonded state is such that separation occurs in the middle of the dielectric layer 3.

Because it is ensured that in this manner the peripheral edge end region of the double-sided copper clad laminate 1c is in an unbonded state, the copper foil layers present on both sides do not come into direct contact with each other and it becomes possible to measure withstand voltage by applying a high voltage. This configuration of the double-sided copper clad laminate is made upon completion of the pressing of the copper clad laminate and should not require special treatment after the manufacturing of an ordinary double-sided copper clad laminate.

Therefore, the method for manufacturing the double-sided copper clad laminate 1c of this configuration is also limited. That is, the method for manufacturing the third double-sided copper clad laminate 1c is as follows. As shown in FIG. 4, by use of two pieces of dielectric-layer-formed copper foil of the same size, which is dielectric-layer-formed copper foil in which a dielectric layer having a prescribed thickness is formed beforehand on a bonding surface of the copper foil, the dielectric layers 3a, 3b of the first dielectric-layer-formed copper foil 5a and the second dielectric-layer-formed copper foil 5b are superposed on each other and pressing is performed with the two surfaces sandwiched with end plates M thereby to obtain the double-sided copper clad laminate 1c.

At this time, the size of the end plates M should be smaller than the size of the first dielectric-layer-formed copper foil 5a and the second dielectric-layer-formed copper foil 5b. When the dielectric layers 3a, 3b of the first dielectric-layer-formed copper foil 5a and the second dielectric-layer-formed copper foil 5b are superposed on each other and sandwiched with the end plates M, pressing is performed so that the peripheral edge end portions of the superposed first dielectric-layer-formed copper foil 5a and second dielectric-layer-formed copper foil 5b protrude with a width of 4 to 6 mm from the peripheral end portions of the end plates M.

When the protruding distance of the outer peripheral edge end portions is less than 4 mm, it is impossible to bring the peripheral edge end portions into an unbonded state due to the resin flow of the resin which constitutes the dielectric layers 3a, 3b during pressing. Conversely, even when this protruding distance exceeds 6 mm, the outer peripheral edge end portions become bonded and it becomes difficult to efficiently manufacture the third double-sided copper clad laminate 1c. Therefore, it is most preferred that this protruding distance be in the range of 4 mm to 6 mm.

In the above-described double-sided copper clad laminate related to the present invention, stable withstand voltage measurement is possible even when the thickness of the dielectric layer is not more than 20 μm. Problems as described above do not tend to arise in the case of a thick double-sided copper clad laminate having a dielectric layer the thickness of which exceeds 30 μm. In the initial stage when a double-sided copper clad laminate begun to be used for the formation of a capacity layer of a multilayer printed wiring board, it was difficult to obtain a thin double-sided copper clad laminate and in almost all cases the thickness of the dielectric layer was 50 μm to 30 μm.

However, when a capacitor is to be constituted by use of a double-sided copper clad laminate, it is required that the capacitance be increased as far as possible by reducing the thickness of the dielectric layer of the double-sided copper clad laminate. For this purpose, a double-sided copper clad laminate having a smaller dielectric layer thickness is required. And as a result of a decrease in the dielectric layer thickness, problems as described above arose and the measurement of withstand voltage in the state of a double-sided copper clad laminate became impossible. As a consequence, both suppliers of double-sided copper clad laminates and purchasers of the double-sided copper clad laminates could not carry out prior quality inspection and such double-sided copper clad laminates got into circulation in the market as products incapable of thoroughgoing quality assurance.

That is, by adopting the configuration of the double-sided copper clad laminates 1a, 1b and 1c described in the present invention, for the first time it becomes possible to carry out in a stable manner the withstand voltage test of a double-sided copper clad laminate for the formation of a capacity layer having a dielectric layer of not more than 30 μm in thickness, enabling thoroughgoing quality assurance to be performed.

Among the double-sided copper clad laminates described above, the first double-sided copper clad laminate shown in FIG. 1 can also be manufactured in the same method as with ordinary copper clad laminates. However, it is possible to adopt a very unique manufacturing method. Also, in the manufacturing method which will be described below, it is possible to continuously mass produce the first double-sided copper clad laminate, thereby dramatically increasing the productivity of double-sided copper clad laminates.

According to a claim there is provided a method for manufacturing the first double-sided copper clad laminate 1a for the formation of a capacity layer which comprises:

the supply step S which involves continuously delivering a roll of dielectric-layer-formed copper foil 6 having a dielectric layer in a semicured state as a dielectric-layer-formed copper foil web, with a dielectric surface layer facing upward, and placing copper foil sheets 8 or dielectric-layer-formed copper foil sheets 8′, both having a width narrower than that of the dielectric-layer-formed copper foil, at prescribed intervals on a dielectric layer 7 of the dielectric-layer-formed copper foil; the laminating step L which involves bringing the copper laminate sheets 8 or resin-formed copper foil sheets 8′ placed on the dielectric layer 7 of the dielectric-layer-formed copper foil web delivered from the roll of dielectric-layer-formed copper foil 6 in the sheet supply step S in close contact without a gap and temporarily laminating the sheets 8 or 8′; the curing step C which involves putting the above-described temporarily clad portions in a curing oven 9 thereby causing a resin composing a dielectric layer 3 to cure; and the cutting step K which involves cutting the laminate to a prescribed size after the completion of curing thereby to obtain a double-sided copper clad laminate.

The flow chart of a method for manufacturing this first double-sided copper clad laminate 1a is shown in FIG. 5. FIG. 5 shows an example of a continuous manufacturing method in which the material flows continuously on a conveyor B. However, even when this manufacturing process is performed by separating the steps, there is no problem at all. This manufacturing will be described below by referring to FIG. 5.

What is used in the sheet supply step S is “a roll of dielectric-layer-formed copper foil 6 having a dielectric layer in a semicured state” and a dielectric-layer-formed copper foil web is delivered from this roll. Dielectric-layer-formed copper foil refers to copper foil in which a dielectric layer is formed beforehand on a bonding surface of the copper foil and in recent years this dielectric-layer-formed copper foil has been widely used in multilayer printed wiring boards. Because this dielectric layer does not contain a skeleton material unlike a glass-epoxy resin substrate, the control of the thickness of the dielectric layer of the copper clad laminate is easy and it is known that this dielectric layer is excellent in laser boring properties during the formation of a via hole. In general, epoxy resins, polyimide resins, etc. are used as the resin used for the formation of this dielectric layer. However, such resins are not especially limited so long as they can be used for the manufacturing of copper clad laminates. And arbitrarily, a dielectric filler such as barium titanate may be caused to be contained in this resin.

Also in the present invention, the dielectric layer 7 of this roll of dielectric-layer-formed copper foil 6 is used as a component material similar to the dielectric layer 3 of the above-described double-sided copper clad laminate 1a. A double-sided copper clad laminate can be obtained by placing the copper foil sheet 8 or resin-formed copper sheet 8′ on the dielectric layer 7 of this roll of dielectric-layer-formed copper foil 6 and laminating the sheet 8 or 8′. However, in the case of the present invention, the above-described first double-sided copper clad laminate 1a is to be manufactured, as is apparent from the sheet supply step S of FIG. 5, and hence it follows that the above-described sheets 8, 8′ are placed at prescribed intervals on the dielectric layer 7 of the dielectric-layer-formed copper foil web which has been continuously unwound, the sheets 8, 8′ having a width narrower than that of the dielectric-layer-formed copper foil web.

Means for placing the copper foil sheet 8 or dielectric-layer-formed copper foil sheet 8′ is not especially limited so long as it can place, with good accuracy, the sheets 8, 8′ in prescribed positions which have been determined beforehand on the dielectric layer 7 of the dielectric-layer-formed copper foil web and besides eliminate the occurrence of wrinkles etc. in the sheets 8, 8′ in a placed state as far as possible. For example, there is available a method which involves placing the sheets 8, 8′ in prescribed positions with good accuracy by use of an adsorption pad as shown in FIG. 5 or a slide shooter (not shown), etc. In order to remove air which penetrates to between the surface of the dielectric layer 7 of the dielectric-layer-formed copper foil web and the above-described sheets during the placing thereof, it is desirable that a certain means be adopted, for example, holding rolls be arranged.

Next, the copper foil sheets 8 or dielectric-layer-formed copper foil sheets 8′ placed on the dielectric layer 7 of the dielectric-layer-formed copper foil web in the sheet supply step S enter the laminating step L in order to be laminated without a gap by completely removing the air which has penetrated in between the sheets 8 or 8′ and this dielectric layer. In this laminating step L, during the traveling between heating rolls, by use of a device what is called “a laminator” the air which has penetrated in between the superposed dielectric-layer-formed copper foil web and the placed copper foil sheets 8 or dielectric-layer-formed copper foil sheets 8′ is removed and the component resin of the dielectric layer softens a little, whereby temporary laminating with the above-described sheets is performed. The temperature of the heating rolls at this time is changed according to the type of the resin composing the dielectric layer and the traveling speed. For example, when a polyimide resin is used, the roll temperature must be higher than when an epoxy-based resin is used.

Portions for which temporary laminating has been completed in the laminating step L enter the curing step C. In this curing step C, by use of the curing oven to perform heating necessary for the curing of the resin composing the dielectric layer, the resin composing the dielectric layer is caused to reflow and cure. Therefore, also the heating temperature is determined according to the traveling time in the curing oven 9 and the type of the resin composing the dielectric layer.

Lastly, when the curing of the resin composing the dielectric layer has been completed, the laminate enters the cutting step K and is cut in portions between the sheets arranged at given intervals by use of a shear cutter 10, which is shown in the figure, a rotary cutter, etc., whereby the first double-sided copper clad laminate 1a can be obtained.

Furthermore, it is preferable to provide, after the cutting step, means for measuring withstand voltage by causing probes for withstand voltage measurement to abut against the copper foil layers on both sides of the cut double-sided copper clad laminate. As shown in FIG. 6, it is possible to assure positive quality related to the withstand voltage of the double-sided copper clad laminate by providing a withstand voltage measurement means T between the cutting step K and the piling, and performing withstand voltage measurement, with each peace of the double-sided copper clad laminate after cutting sandwiched between the probes 12 for withstand voltage measurement.

### BRIEF DESCRIPTION OF THE DRAWINGS

FIGS. 1(A) and 1(B) are each a view showing a double-sided copper clad laminate related to the invention;

FIGS. 2(A) and 2(B) are each a view showing a double-sided copper clad laminate related to the invention;

FIGS. 3(A) and 3(B) are each a view showing a double-sided copper clad laminate related to the invention;

FIG. 4 is a schematic representation of a method for manufacturing double-sided copper clad laminate related to the invention;

FIG. 5 is a schematic representation of a concept of the layout of an apparatus for continuously manufacturing double-sided copper clad laminate related to the invention;

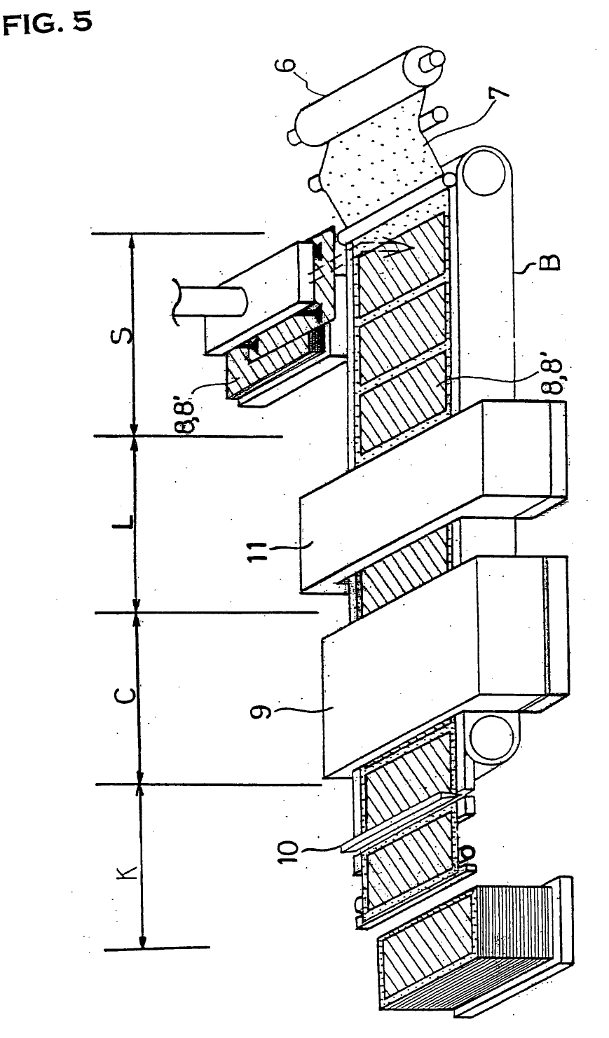

FIG. 6 is a schematic representation of a concept of the layout of an apparatus for continuously manufacturing double-sided copper clad laminate provided with withstand voltage measuring means related to the invention;

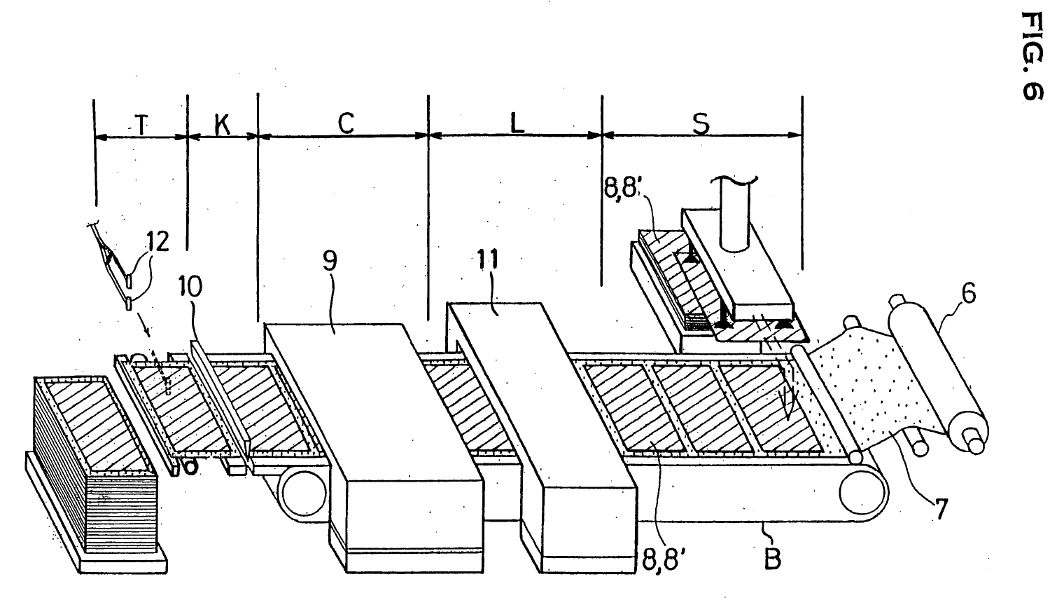

FIGS. 7(A) and 7(B) are each a schematic representation of a problem which has arisen in a conventional double-sided copper clad laminate; and

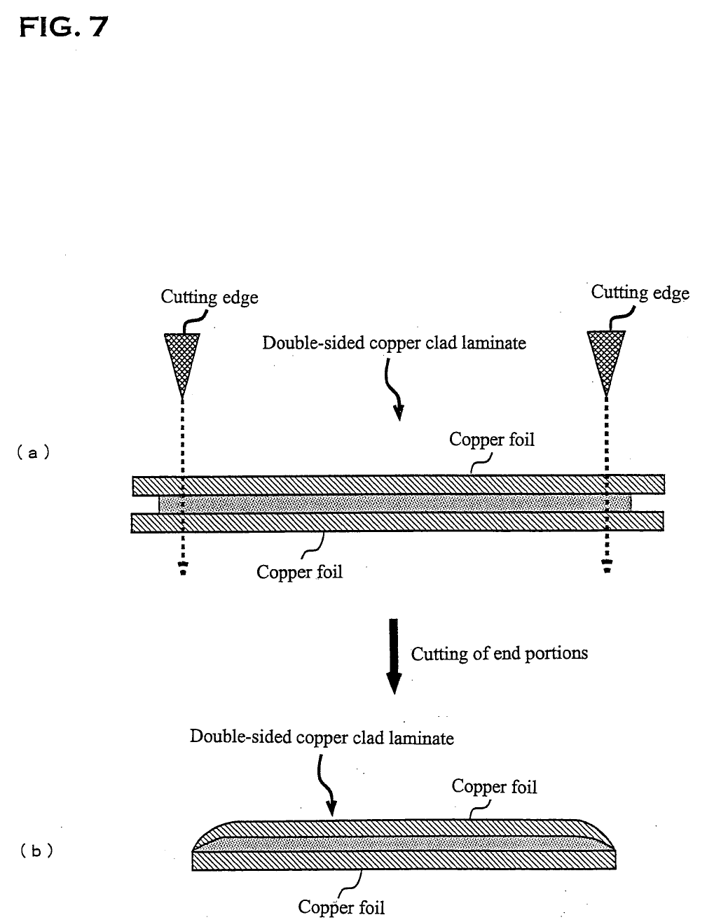

FIG. 8 is a schematic representation of a problem which has arisen in a conventional double-sided copper clad laminate.

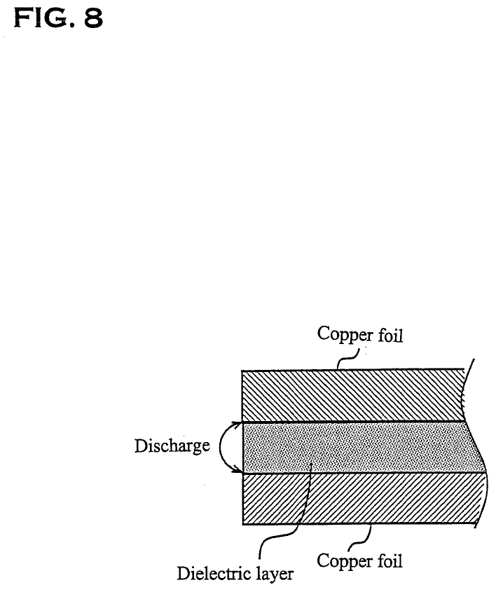

### DETAILED DESCRIPTION OF THE PREFERRED EMBODIMENTS

Embodiments of the double-sided copper clad laminate related to the present invention will be described below. Incidentally, materials used to compose the dielectric layer, which will be described below, are common to all of the embodiments and were prepared as follows.

First, a binder resin solution was produced. In producing this binder resin solution, BP3225-50P made by NIPPON KAYAKU CO., LTD., which is commercially available as a mixed varnish of 25 parts of phenolic novolak type epoxy resin by weight, aromatic polyamide resin polymer soluble in 25 parts of solvent by weight and cyclopetane as a solvent, was used as a raw material. The resin mixture having the following blending ratios was obtained by adding a novolak type phenol resin as a curing agent, MEH-7500 made by Meiwa Chemicals Co., Ltd. and 2E4MZ made by Shikoku Corp. as a curing accelerator to this mixed varnish.

Binder Resin Composition

| | | |
|---|---|---|
| Phenolic novolak type epoxy resin | 39 | parts by weight |
| Aromatic polyamide resin polymer | 39 | parts by weight |
| Novolak type phenol resin | 22 | parts by weight |
| Curing accelerator | 0.1 | part by weight |

The resin solid content of this resin mixture was further adjusted to 30% by weight by use of methyl ethyl ketone, whereby the binder resin solution was obtained. A barium titanate powder, which is a dielectric filler having the powder characteristics shown below, was mixed and dispersed in this binder resin and a dielectric-filler-containing resin solution having the following composition was obtained.

Powder Characteristics of Dielectric Filler

| | | |
|---|---|---|
| Average particle diameter (D_{IA}) | 0.25 | μm |
| Weight-cumulative particle diameter (D₅₀) | 0.5 | μm |
| Degree of aggregation (D₅₀/D_{IA}) | 2.0 | |

Dielectric-Filler-Containing Resin Solution

| | | |
|---|---|---|
| Binder resin solution | 83.3 | parts by weight |
| Barium titanate powder | 100 | parts by weight |

The dielectric-filler-containing resin solution produced as described above was used as a component material of the dielectric layer.

### EXAMPLE 1

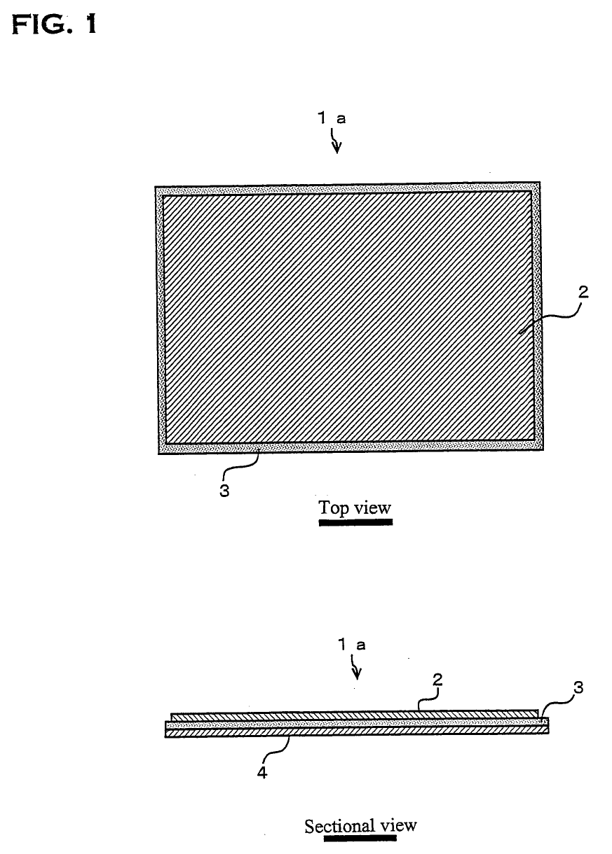

In this example, the double-sided copper clad laminate 1a shown in FIGS. 1(A) and 1(B) was fabricated. In this example, 18 μm thick electrolytic copper foil was used as the second copper foil 4 in order to form the dielectric layer 3 on a roughened surface of the second copper foil 4 of FIG. 1(A), the dielectric-filler-containing resin solution was applied to this bonding surface by use of an edge coater to form a dielectric-filler-containing resin film with a prescribed thickness, air drying was performed for 5 minutes, and after that, drying was performed for 3 minutes in a heating atmosphere at 140° C., whereby a 20 μm thick dielectric layer 3 in a semicured state was formed. The size of the second copper foil was 500 mm×500 mm at this time.

When the formation of the dielectric layer 3 was completed, the bonding surface side of the first copper foil 2 (electrolytic copper foil similar to the first copper foil) was caused to abut against the dielectric layer 3 of this second copper foil 4, laminating was performed, and hot pressing was performed under the heating conditions of 180° C.×60 minutes, whereby the state of the double-sided copper clad laminate 1a was produced. At this time, the size of the first copper foil 2 was 499 mm×499 mm hence smaller than the second copper foil.

The number of the double-sided copper clad laminates 1a thus fabricated was 20, and withstand voltage measurement was carried out in the as-fabricated double-sided copper clad laminates 1a. The withstand voltage measurement was carried out by applying the voltages of 500 V, 750 V and 1000 V. As a result, in all of the double-sided copper clad laminates 1a, the withstand voltage measurement could be carried out well without causing the shortage phenomenon.

### EXAMPLE 2

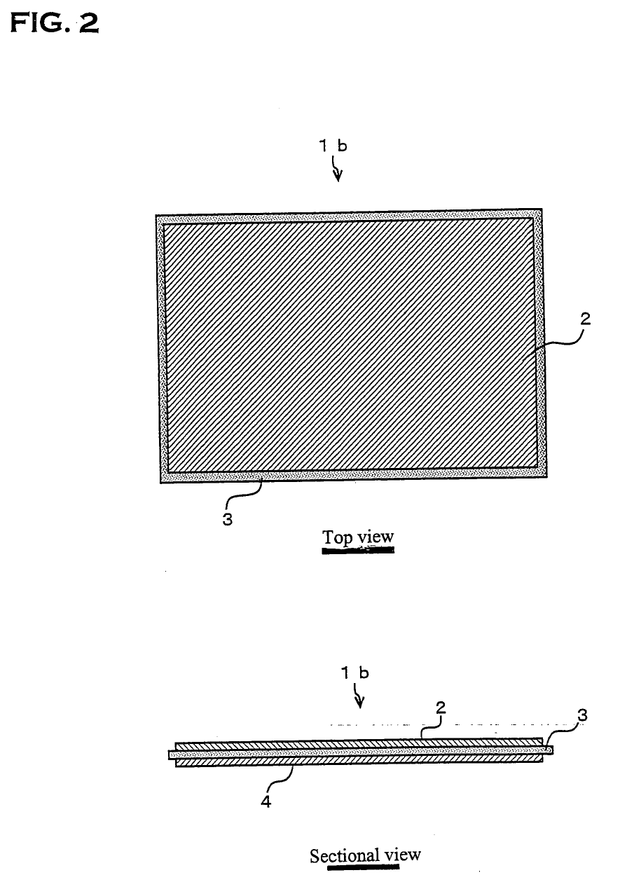

In this example, the double-sided copper clad laminate 1b shown in FIGS. 2(A) and 2(B) was fabricated. In this example, first, a mirror finished stainless steel sheet was prepared. The dielectric-filler-containing resin solution was applied to this stainless steel sheet by use of an edge coater to form a dielectric-filler-containing resin film with a prescribed thickness, air drying was performed for 5 minutes, drying was then performed for 3 minutes in a heating atmosphere at 140° C., and the stainless steel sheet was formed in the shape of a sheet (hereinafter referred to as a “dielectric sheet”) to form a 20 μm thick dielectric layer 3 in a semicured state. The size of the dielectric sheet was 500 mm×500 mm at this time.

When the dielectric sheet was completed, a bonding surface of 18 μm thick electrolytic copper foil having a size of 498 mm×498 mm was caused to abut against each of both sides of this dielectric sheet, laminating was carried out so that the peripheral end portions of the dielectric sheet protrude uniformly from the peripheral end portions of the copper foil, and hot pressing was performed under the heating conditions of 180° C.×60 minutes, whereby the state of the double-sided copper clad laminate 1b was produced.

The number of the double-sided copper clad laminates 1b thus fabricated was 20, and withstand voltage measurement was carried out in the as-fabricated double-sided copper clad laminates 1b. The withstand voltage measurement was carried out by applying the voltages of 500 V, 750 V and 1000 V. As a result, in all of the double-sided copper clad laminates 1b, the withstand voltage measurement could be carried out well without causing the shortage phenomenon.

### EXAMPLE 3

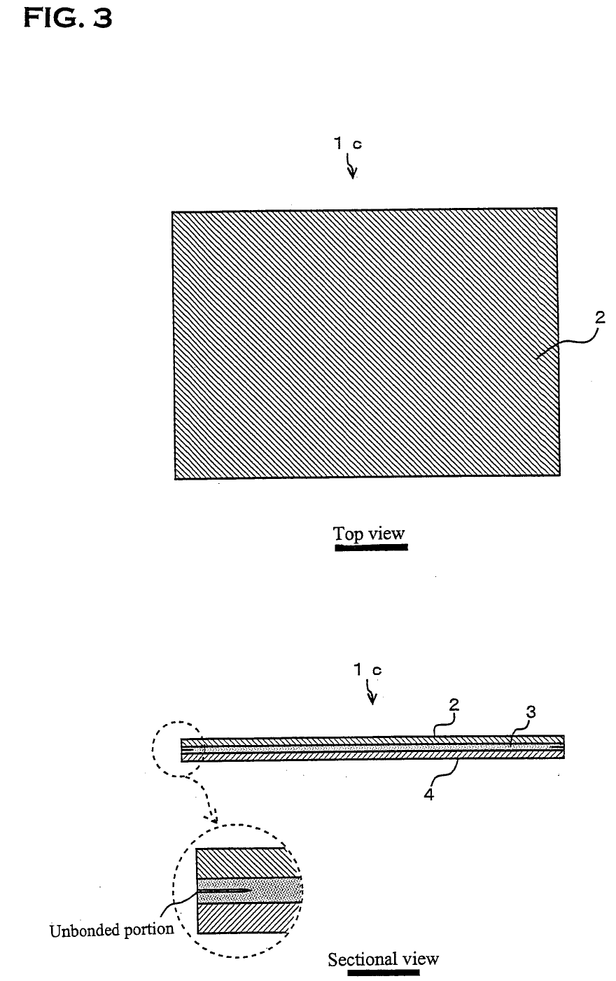

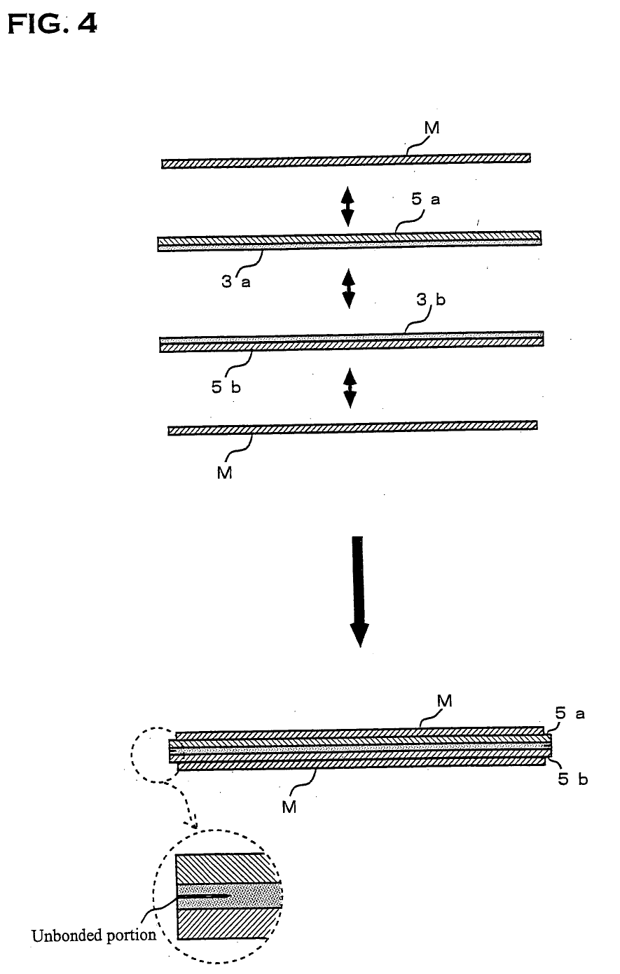

In this example, the double-sided copper clad laminate 1c shown in FIGS. 3(A) and 3(C) was fabricated by the manufacturing method shown in FIG. 4. In this example, in order to form the dielectric layer 3 on the bonding surfaces of the first dielectric-layer-formed copper foil 5a and second dielectric-layer-formed copper foil 5b, 18 μm thick electrolytic copper foil was each used, and by use of an edge coater the dielectric-filler-containing resin solution was applied to the bonding surfaces so as to form a dielectric-filler-containing resin film with a prescribed thickness, air drying was performed for 5 minutes, and after that, drying was performed for 3 minutes in a heating atmosphere at 140° C., whereby a 20 μm thick dielectric layer 3 in a semicured state was formed. The size of the first dielectric-filler-formed copper foil 5a and second dielectric-filler-formed copper foil 5b was 500 mm×500 mm at this time.

The respective dielectric layers 3a, 3b of the first dielectric-filler-formed copper foil 5a and second dielectric-filler-formed copper foil 5b obtained as described above were caused to abut against each other, end plates M having a size of 495 mm×495 mm were disposed in the center portion, laminating was performed by sandwiching the first dielectric-filler-formed copper foil 5a and second dielectric-filler-formed copper foil 5b so that the peripheral end portions of the first dielectric-filler-formed copper foil 5a and second dielectric-filler-formed copper foil 5b protrude uniformly from the end plates, and hot pressing was performed under the heating conditions of 180° C.×60 minutes, whereby the state of the double-sided copper clad laminate 1c was produced.

The number of the double-sided copper clad laminates 1c thus fabricated was 20, and withstand voltage measurement was carried out in the as-fabricated double-sided copper clad laminates 1c. The withstand voltage measurement was carried out by applying the voltages of 500 V, 750 V and 1000 V. As a result, in all of the double-sided copper clad laminates 1c, the withstand voltage measurement could be carried out well without causing the shortage phenomenon.

By forming a dielectric layer present between layers of a copper clad laminate by use of resin compounds related to the present invention, it becomes possible to substantially improve both of the heat resistance and thermal resistance related to copper clad laminates or printed wiring boards, to supply copper clad laminates which facilitate the formation of fine pitch circuits and laser boring and furthermore to enormously increase the safety reliability during the manufacturing and use of printed wiring boards. Therefore, the present invention prevents firing accidents in home electric appliances, various kinds of electronic devices, etc. and permits the supply of products which are excellent from the standpoint of product reliability. In addition, the resin compounds related to the invention do not contain halogen elements and are desirable products also from the standpoint of natural environmental preservation.

What is claimed is:

1. A double-sided copper clad laminate for the formation of a capacity layer in which copper foil is clad to both sides of a dielectric layer, wherein the copper foil shape on both sides of the double-sided copper clad laminate is in an analogous relation, with the size of first copper foil on one side being smaller than that of second copper foil on the other side, the first copper foil and the second copper foil being disposed concentrically via the dielectric layer, and wherein a peripheral portion of an edge end of the side of the double-sided copper clad laminate to which the first copper foil is clad has a dielectric region in which said dielectric layer is exposed.

2. The double-sided copper clad laminate for the formation of a capacity layer according to claim 1, wherein said dielectric region has a width which is not less than V×1 μm from the edge end portion of the double-sided copper clad laminate, a load voltage during the measurement of withstand voltage being expressed by V volt.

3. A double-sided copper clad laminate for the formation of a capacity layer in which copper foil is clad to both sides of a dielectric layer, wherein the shape of first copper foil on one side of the double-side copper clad laminate and that of second copper foil on the other side are almost the same, the first copper foil and the second copper foil being disposed concentrically via the dielectric layer, and wherein the dielectric layer protrudes beyond the edge end portions of the first copper foil and the second copper foil.

4. The double-sided copper clad laminate for the formation of a capacity layer according to claim 3, wherein the protruding distance is not less than V×1 μm from the edge end portion of the double-sided copper clad laminate, a load voltage during the measurement of withstand voltage being expressed by V volt.

5. A double-sided copper clad laminate for the formation of a capacity layer which uses first dielectric-layer-formed copper foil, which is dielectric-layer-formed copper foil in which a dielectric layer having a prescribed thickness is formed beforehand on a bonding surface of the copper foil, and this dielectric layer and that of second dielectric-layer-formed copper foil are clad together, wherein in only a region of a peripheral edge end of the double-sided copper clad laminate having a width of not less than 5 mm, the dielectric layers of the first dielectric-layer-formed copper foil and the second dielectric-layer-formed copper foil are in an unbonded state.

6. The double-sided copper clad laminate for the formation of a capacity layer according to any one of claims 1 to 5, wherein the dielectric layer has a thickness of not more than 30 μm.

7. A method for manufacturing the double-sided copper clad laminate for the formation of a capacity layer according to claim 1 or 2, comprising:
a sheet supply step which involves continuously delivering a roll of dielectric-layer-formed copper foil having a dielectric layer in a semicured state as a dielectric-layer-formed copper foil web, with a dielectric surface layer facing upward, and placing copper foil sheets or dielectric-layer-formed copper foil sheets, both having a width narrower than that of the dielectric-layer-formed copper foil, at prescribed intervals on a dielectric layer of the dielectric-layer-formed copper foil;
a laminating step which involves bringing the copper foil sheets or resin-formed copper foil sheets placed on the dielectric layer of the dielectric-layer-formed copper foil web delivered from the roll of dielectric-layer-formed copper foil in the sheet supply step in close contact without a gap and temporarily laminating the sheets;
a curing step which involves putting said temporarily clad portions in a curing oven thereby causing a resin composing a dielectric layer to cure; and
a cutting step which involves cutting the laminate to a prescribed size after the completion of curing thereby to obtain a double-sided copper clad laminate.

8. The method for manufacturing the double-sided copper clad laminate for the formation of a capacity layer according to claim 7, wherein withstand voltage measuring means which causes probes for withstand voltage measurement to abut against the copper foil layers on both sides of the cut double-sided copper clad laminate is provided after the cutting step.

9. A method for manufacturing a double-sided copper clad laminate for the formation of a capacity layer according to claim 5 which uses first dielectric-layer-formed copper foil, which is dielectric-layer-formed copper foil in which a dielectric layer having a prescribed thickness is formed beforehand on a bonding surface of the copper foil, which involves causing this dielectric layer and that of similar second dielectric-layer-formed copper foil to abut with each other, superposing these dielectric layers on each other, sandwiching these dielectric layers between end plates and cladding these dielectric layers together by hot pressing, wherein the size of the end plates is such that the peripheral edge end portions of the first dielectric-layer-formed copper foil and second dielectric-layer-formed copper foil protrude with a width of 4 to 6 mm from the peripheral end portions of the end plates.
